(19) United States
(12) Patent Application Publication
(10) Pub. No.: US 2020/0327782 A1
(43) Pub. Date: Oct. 15, 2020

(54) PRESENTATION APPARATUS (IOT)

(71) Applicants: Chow Tai Fook Jewellery Company Limited, Hong Kong (HK); Megasoft Limited, Hong Kong (HK)

(72) Inventors: Siu Kee Wong, Hong Kong (HK); Siu Kwong Tsang, Hong Kong (HK); Chun Sing Matthew Man, Hong Kong (HK)

(21) Appl. No.: 16/914,502

(22) Filed: Jun. 29, 2020

Related U.S. Application Data
(63) Continuation-in-part of application No. 15/023,909, filed on Mar. 22, 2016.

(30) Foreign Application Priority Data
Sep. 23, 2013 (HK) 13110832.6

(51) Int. Cl. G07G 1/00; G06K 7/10; H01Q 1/22

(52) U.S. Cl. CPC G07G 1/0081; G07G 1/009; G07G 1/0063; H01Q 1/2216; G06K 7/10386; G06K 7/10881; G07G 1/0072

(57) ABSTRACT

A serving apparatus including a main housing, a main receptacle, a checkout port, a display region including a display device, an RFID first detector including a first antenna, an RFID second detector including a second antenna, a data storage device, and a processor is disclosed. The RFID first detector is configured to detect and collect RFID signals coming in from the receptacle and to register a detected article as a checked-in article. The RFID second detector is RF isolated from the RFID first detector and configured to check out a checked-in article. The processor is configured to classify a checked-in article as a floating article if the checked-in article is not detected by the RFID first detector or the RFID second detector for a time exceeding a threshold time.

### CONTINUATION INFORMATION

This is a continuation-in-part application of U.S. Ser. No. 15/023,909, which is a US national entry of PCT/IB2014/064754 and which claims priority from Hong Kong patent application number 13110832.6, filed 23 Sep. 2013. All the above are hereby incorporated by reference.

### FIELD

The present disclosure relates to apparatus for presentation, and more particularly, to presentation apparatus for presenting valuable or precious articles to customers or potential customers with an aim of facilitating purchasing transaction.

### BACKGROUND

Many consumers enjoy shopping at ‘real’ or ‘physical’ shops so that they can feel, touch and closely examine real products as well as comparing products. In addition, many physical shops have shop attendants available to provide personal services such as real time product information, product comparison, advice and comparable products to assist a customer to make purchasing decisions.

During a shopping session, shop assistants often provide customers with many articles to compare with and to choose from. In many shopping occasions, several expensive and/or delicate items such as watches, jewelry, smart phones, or ornamental items may be placed on a presentation apparatus for customer viewing, examination and selection. Such presentation apparatus in retail business is commonly referred to as customer serving trays. A customer serving tray usually includes a main receptacle which allows open access by a viewer so that a viewer can access and remove articles on the tray for examination, close viewing or appreciation before making a purchase decision. Where the items are small and portable, tracking of article movements between a customer and a shop assistant can be difficult, especially when several items are placed on a customer serving tray to promote multiple purchase.

The value or preciousness, and therefore the price, of precious and/or valuable articles are often determined by properties and characteristics associated with the articles. Such properties and characteristics may be multifaceted, time variant and time invariant, and include, for example, design, shape, grading, uniqueness or rarity, material purity, weight or size, and/or price. It would be desirous if information on those properties and characteristics can be readily available at the time when presentation of an article is required.

### SUMMARY OF DISCLOSURE

A customer serving apparatus equipped with RFID detectors to monitor and track movement of articles during a customer serving session is disclosed. The customer serving apparatus, nicknamed “iTray” herein, is primarily a desktop apparatus, for example in the form of a portable tray, for use in retail services, especially in the retail of luxurious items such as jewelry, precious ornaments, pens and watches.

The serving apparatus comprises a main receptacle for holding articles for customer selection, a RFID first detector to detect product identification information associated with an article when said article is first introduced into said main receptacle during a serving session, a data storage device and a processor; wherein the processor is to collect and store said product identification information for use at end of said serving session.

In some embodiments, the serving apparatus comprises a main housing, a main receptacle, a checkout port, a display region including a display device, an RFID first detector including a first antenna, an RFID second detector including a second antenna, a data storage device, and a processor to function as a controller. The RFID first detector is configured to detect and collect RFID signals coming in from the receptacle and to register a detected article as a checked-in article. The RFID second detector is RF isolated from the RFID first detector and configured to check out a checked-in article. The processor is configured to classify a checked-in article as a floating article if the checked-in article is not detected by the RFID first detector or the RFID second detector for a time exceeding a threshold time

The processor may be configured to collect and store product identification information associated with articles introduced into said main receptacle until receipt of a signal signifying end of said serving session.

The processor may be configured to collect and store customer specific information and to associate said customer specific information with said stored product identification information associated with said articles at the end of said serving session, said customer specific information being specific to a customer of said serving session.

The customer specific information may include one or more of the following types of information of a customer: gender, age, demographic data, articles purchased, purposes of or events leading to purchase in said serving session.

The processor may be configured to cause a selected portion of said product identification information associated with an article to be displayed on said apparatus, said product identification information including one or more of the following product identification, product appearance, weight, unit price, available discount.

The RFID first detector comprises a wireless sensor and the product identification information associated is carried on an RFID (radio frequency identification) tag attached to the article.

The RFID tag may be in the form of a folded sheet.

The RFID tag may carry human readable product identification information.

The processor is configured to continuously track presence of an article on the main receptacle after first introduction of said article onto said main receptacle through continuous detection of RFID signals emitted by a tag associated with said article.

The apparatus may comprise a telecommunications frontend to facilitate retrieval of product identification information from a remote source and to upload information collected during a serving session to a remote destination.

More specifically, a serving apparatus comprising a main housing, a main receptacle, a checkout port, a display device adjacent to the main receptacle, a data storage device, an RFID first detector comprising a first antenna, an RFID second detector comprising a second antenna, and a processor is disclosed.

The main receptacle may comprise a main surface for holding a plurality of RFID tagged articles for customer viewing and selection.

The first antenna may be configured to detect RFID signals of RFID tagged articles on the main receptacle, and may be radio-frequency shielded to prevent or mitigate against detection of RFID signals of an RFID tagged article placed at the checkout port.

The second antenna may be configured to detect RFID signals of an RFID tagged article which is outside the main housing, which is present at the checkout port, and which is not on the main receptacle.

The second antenna may be radio-frequency shielded to prevent or mitigate against detection of RFID signals of an RFID tagged article placed on the main receptacle, and may be radio-frequency isolated from the first antenna.

The processor may be configured to operate the RFID first detector to continuously detect and collect RFID signals of an RFID tagged article or a plurality of RFID tagged articles on the main receptacle, to check in or register an RFID tagged article as a checked-in article when the RFID tagged article is detected by the first antenna of the RFID first detector for a first time during a serving session, and to collect and store product identification information of the checked-in article in the data storage device.

The processor may be configured to operate the RFID second detector to detect RFID signals of an RFID tagged article presented at the checkout port, and to checkout or deregister a checked-in article as a checked-out article when the RFID signals of the checked-in article are detected by the second antenna of the RFID second detector.

The processor may be configured to determine and classify a checked-in article as a floating article if the checked in article is not detected by the RFID first detector or the RFID second detector for a floating time exceeding a threshold time, and to generate and store absence information of the article, the absence information including product identification information of the floating article, the floating time, the total floating time and/or number of absence of the checked in article during the serving session.

The main surface comprises an upward-facing planar surface. The first antenna may be disposed intermediate the upward-facing planar surface and a metal casing for maximal detection of RFID signals coming from the main surface and for minimal detection of RFID signals coming from other orientations.

The first antenna is typically a distributed antenna having planar detection elements which define a detection plane, the detection plane being parallel to a top surface of the metal casing; and wherein the first antenna is mounted immediately underneath the main receptacle and sits on the top surface of the metal casing, the top surface of the metal casing being parallel to the main surface of the main receptacle.

The top surface of the metal casing may have a planar extent which is comparable to the planar extent of the main surface of the receptacle.

The second antenna may be configured to detect RFID signals of a localized RFID signal source which is outside the apparatus.

The first antenna may be configured to detect RFID signals coming to the first antenna in a first axial direction which is a downward direction. The second antenna may be configured to detect RFID signals coming to the second antenna in a second axial direction which is an inward direction orthogonal to the first axial.

The first antenna may have a horizontal detection surface and the second antenna may have a vertical detection surface.

The first antenna may be a distributed antenna having a detection area covering the main receptacle, and wherein the second antenna has a detection area which is smaller than the detection area of the first antenna and which covers the checkout port.

The first antenna may be a distributed antenna having a detection range covering the main receptacle, and wherein the checkout port is outside the detection range of the first antenna.

The second antenna may have an outward-facing front side and an inward-facing backside, and wherein the backside is radio-frequency shielded to prevent detection of residual RFID signals coming in from the first antenna.

The front side of the second antenna is preferably adjacent the checkout port.

The main housing may comprise an upper housing portion and a lower housing portion which cooperate to form the main housing, and wherein the main receptacle is formed on a top surface of the main housing and the main surface of the main receptacle is upward facing, and wherein the checkout port is formed on a lateral side of the main housing and a portion on the lateral side of the main housing which is opposite-facing the second antenna is formed as a grille-shaped checkout port.

The main receptacle may be formed as an indented portion on a top surface of the main housing, and wherein the main surface is depressed below the top surface and surrounded by an upwardly extending peripheral wall.

The first antenna may sit on a metal casing having a skirt, and wherein the peripheral wall is a skirt of the metal casing.

The apparatus may comprise a first RF signal path which comprises the RFID first detector and a second RF signal path which comprises the RFID second detector, and wherein the second RF signal path is radio-frequency isolated from the first RF signal path.

The processor may be configured to display a selected portion of the absence information and a selected portion of the product identification information of the floating articles on the display device during the serving session, the product identification information including one or more of the following: shape, appearance, style, weight, price, material, grade, purity, number in stock, and available discount.

The processor may be configured to use the absence information to form a viewing history of viewed checked in articles after the serving session; and wherein the viewing history includes the product identification information of the checked in articles, the product identification information of the checked in articles which were removed for viewing, the number of viewings per checked in article, the total viewing duration of the checked in articles viewed, and/or the checked in articles purchased.

The processor may be configured to collect and store customer specific information and to associate said customer specific information with the viewing history; and wherein the customer specific information includes one or more of the following types of information of a customer: gender, age, demographic data, articles purchased, purposes of or events leading to purchase in said serving session.

### DESCRIPTION OF FIGURES

The present disclosure will be described by way of example with reference to the accompanying Figures in which:—

FIG. 1 is a first perspective view showing a presentation apparatus according to an example of the present disclosure,

FIG. 1A is a second perspective view of the apparatus of FIG. 1,

FIG. 1B is a top plan view of the apparatus of FIG. 1,

FIGS. 1C and 1D are side elevation views showing lateral sides of the apparatus of FIG. 1,

FIG. 1E is a cross-sectional view of the example apparatus of FIG. 1 taken along line A-A′ of FIG. 1B,

FIG. 1F is a bottom plan view of the apparatus of FIG. 1,

FIG. 2 is a schematic block diagram of example operation circuitry for use on the example apparatus of FIG. 1,

FIG. 2A is a schematic block diagram of example operation circuitry installed on the example apparatus of FIG. 1,

FIG. 2B is a schematic block diagram of the example circuitry of FIG. 2B in more detail,

FIG. 2C is a schematic diagram depicting example arrangement and operation of the RFID module of FIG. 2B,

FIG. 2D is a schematic circuit diagram depicting example implementation of the RFID module of FIG. 2C,

FIG. 3A is a top perspective view showing the apparatus of FIG. 1 after removal of the top panel and the article detection antenna,

FIG. 3B is a top plan view showing the apparatus of FIG. 3A with the article detection antenna in place,

FIG. 3C is a schematic view depicting an example antenna element layout suitable for use as an alternative antenna,

FIGS. 4A and 4B are schematic diagrams depicting information displayed on the first display and the second display when the apparatus is in stand-by mode awaiting access request and authorization,

FIGS. 5A and 5B are schematic diagrams depicting information displayed on the first display and the second display when the apparatus is in an initial operational state,

FIG. 6 is a flow diagram depicting example operation of the apparatus of FIG. 1,

FIG. 6A is a flow diagram depicting example operation of the apparatus of FIG. 1,

FIG. 6B is a flow diagram depicting example processor operation of the apparatus of FIG. 1,

FIGS. 7A and 7B respectively show the first and second displays of the apparatus of FIG. 1 when in an operation state,

FIGS. 8A and 8B respectively show the first and second displays of the apparatus of FIG. 1 when in another operation state,

FIGS. 9A and 9B respectively show the first and second displays of the apparatus of FIG. 1 when in an operation state following that of FIGS. 8A and 8B,

FIGS. 10A and 10B respectively show the first and second displays of the apparatus when one of the three articles on the main receptacle is checked out,

FIG. 11A is a flow diagram depicting a flow of operations of the processor upon initialization and detection of article identification data,

FIG. 11B is a flow diagram depicting a flow of operations of the processor to obtain article specific information,

FIG. 12 is a flow diagram depicting a mode of processor operations after end of a viewing session, and

FIGS. 12A to 12D are example icons to appear during an end of viewing session data collection process.

### DESCRIPTION OF DISCLOSURE

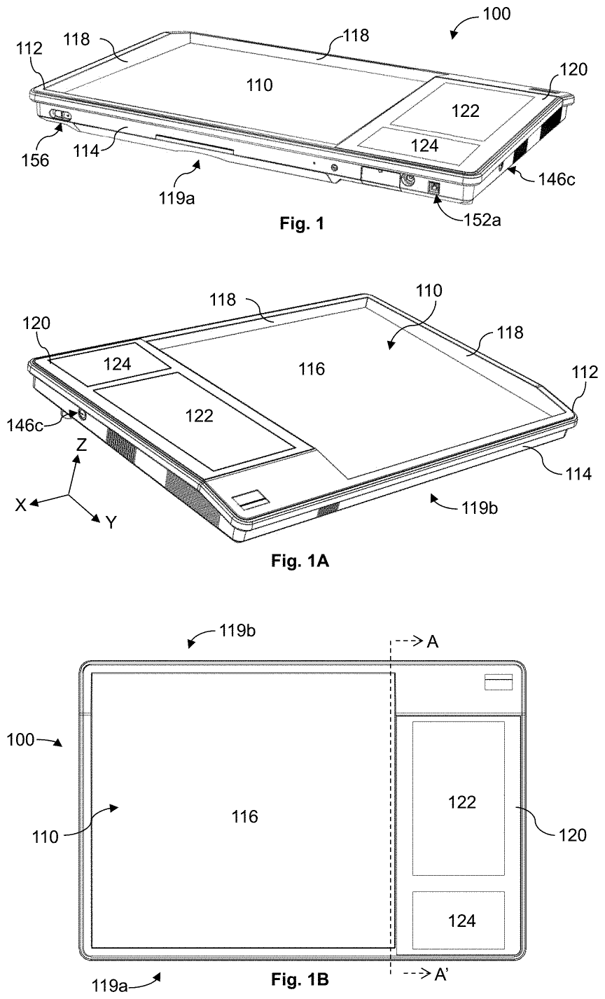

A presentation apparatus 100 depicted in FIGS. 1 and 1A to 1F comprises a main receptacle 110 and a display region 120 comprising a first display 122 and a second display 124. The main receptacle 110 and the display region 120 are disposed on a main housing, with the display region on a lateral side of the apparatus adjacent the main receptacle 110. The main housing is made of hard plastics and comprises an upper housing 112 and a lower housing 114 which are in axial alignment and in mechanical engagement. The main housing defines a rigid structure and a hollow internal compartment to house operational electronics to facilitate operations of the apparatus 100. The main housing is a fastened assembly of the upper housing 112 and the lower housing 114.

The main receptacle 110 and the display region 120 are formed on the upper housing 112 with the main receptacle 110 on one lateral side of the upper housing 112 and the display region 120 on the other lateral side of the upper housing 112. The main receptacle 110 is formed as an indented portion on the top surface of the upper housing 112 and is in the form of a tray having a main surface 116 surrounded by a peripheral wall 118. The main surface 116 of the tray defining the main receptacle 110 is at a depressed level below the top surface of the upper housing 112 and extends between an operator's end 119a and a viewer's end 119b of the apparatus. The peripheral wall 118 extends upwardly (Z-direction of FIG. 1A) from boundary of the main surface 116 to surround the main surface and to connect the main surface of the tray to the top surface of the upper housing. The main surface of the tray is open to external access and defines an open tray which is covered with a soft material such as velvet, silk, polyamide or other soft fabrics so that precious articles such as jewelry items can be placed on the tray for customer viewing, appreciation and examination. The tray is to facilitate a viewer to view and access articles on the main receptacle and to facilitate a viewer to remove an article for close examination or appreciation. To facilitate such open access and viewing, the tray is relatively shallow having a typical depth of between 1 cm and 3 cm.

When the apparatus 100 is placed on a leveled support surface during use, the main surface of the tray is parallel or substantially parallel to the support surface so that precious and/or valuable articles placed on the main receptacle will stay at the placing location unless intentionally moved by an operator or a customer. When in use, the apparatus is to be placed between an operator and a viewer so that the operator and the viewer are at opposite ends of the main receptacle with equal or substantially equal visibility and accessibility to articles on the tray.

The upper housing 112 includes an inclined portion which is on a lateral side of the apparatus and adjacent the main receptacle 110 to define the display region 120. The display region 120 is inclined towards the operator's end and is disposed such that the display region is to face the operator and to face away from a viewer during a viewing session when the operator is proximal the operator's end and the viewer proximal the view's end. As the display region is inclined to face the operator during use, the information shown on the display region will be readily readable by the operator but not so readily readable by the viewing customer unless with assistance of the operator or through deliberate movement of the viewing customer which will be noticeable by the operator or assistants in the vicinity.

The inclined display region is formed on the upper housing and extends between an elevated ridge and the operator's end. The elevated ridge is formed near the viewer's end and extends transversally from a lateral boundary of the main receptacle to a lateral edge of the upper housing. The display portion inclines gradually from the elevated ridge and stops at the operator's end. The inclination of the display region is designed to facilitate comfortable viewing of information by the operator while sufficient to hide information being displayed on the display portion from the viewer when sitting at the viewer's end. The upper housing includes another inclined portion which extends between the elevated ridge and the viewer's end. The two inclined portions are oppositely facing and cooperate to define a housing portion extending between the opposite ends of the upper housing and resembling a ridged roof as depicted in FIGS. 1C and 1D. The display region 120 is inclined relative to the main surface of the tray so that a viewer at the viewer's end can have a full view of the tray but not the display region, which is inclined to face away from the viewer's end. In use, the apparatus is intended to be positioned between an operator and a viewer, with the display region facing the operator and facing away from the viewer. A viewer is typically a customer or a potential customer but can be other people such as an interviewee, a valuator or a staff.

The display region comprises a first display 122 comprising a first LCD display and a second display 124 comprising a second LCD display. The first LCD display is mounted on a first window formed on the display region and the second LCD display is mounted on a second window between the first window and the operator's end.

To provide a sufficient useable area to hold precious articles for display and viewing, the main surface of the tray is to make up a substantial portion of the surface area of the upper housing while the display region will take up most of the remaining surface area of the upper housing so that sufficient information can be displayed during operations. In general, the main surface of the tray would make up around 65%-80% of the total projected area of the upper housing in the vertical direction while the display region will take up about 15-30% of that area. Of course, the proportion of the area of the main surface of the tray to the projected area of the apparatus or the proportion of the area of the display region to the projected area of the apparatus is variable and very much dependent on actual requirements or operation environment. In general, an inclination of the display region in the region of between 1.5° to 10° would be useful, while a lower inclination angle of say between 1.5° to 3°, or 2° to 5° would be less noticeable to a viewing customer.

In a portable version of the example apparatus 100 as depicted in FIG. 1, the apparatus has the following example dimensions, in which the directions are indicated by arrows of FIG. 1:

| | Width (mm) | Depth (mm) | Height (mm) | |
|---|---|---|---|---|
| | (x-direction) | (y-direction) | (z-direction) | |
| Apparatus (100) | 440 | 293 | 24.95 | |
| Main receptacle (110) | 298 | 268 | 11.2 (min) | 18.1 (max) |
| Display region | 122 | 234 | | |
| First display (7″ LCD) | 90 | 151 | | |
| second display (4″ LCD) | 90 | 57 | | |

| | |
|---|---|
| Display region inclination | 1.85° |
| Display region to apparatus area ratio % | 22% |
| Apparatus weight with battery (kg) | 2.5 |
| Apparatus weight without battery (kg) | 2.0 |

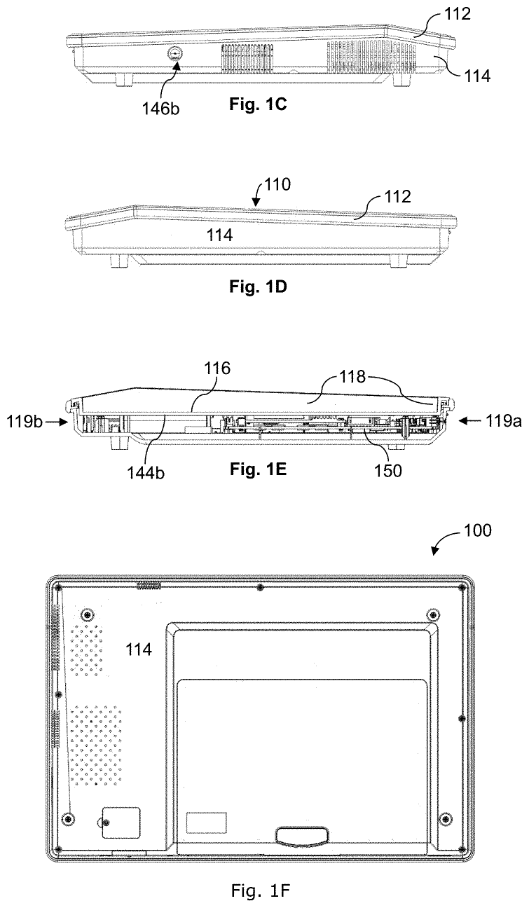

The example apparatus 100 includes example detection and display circuitry 140 depicted in FIG. 2. The detection and display circuitry 140 comprises a processing device 142, a first detection device 144, a second detection device 146, a first display device 122a and a second display device 124a. The first and second detection devices 144, 146 and the first and second display devices 122a, 124a are connected to the processing device 142 so that information collected through the first and second detection devices 144, 146 are output to the first and second display devices 122a, 124a for display after having processed by the processing device 142. The apparatus 100 may include a telecommunications interface 154 to facilitate data communication with external devices. The processing device 142 may include a single processor such as a single CPU (central processing unit), a plurality of processors each having individually designated duties or tasks, or a cluster of processors to facilitate distributed processing without loss of generality.

The detection and display circuitry 140 of this example apparatus is built around RFID (radio frequency identification) applications. In particular, the example detection and display circuitry 140 is built around the Class 1 Generation 2 RFID standard to operate in the UHF frequency range of 860 MHz to 960 MHZ. An RFID system built around this standard, also known as “EPC Gen 2” standard is attractive since the system is compatible with passive RFID tags of low per unit costs. Details of this standard, known as “UHF Air Interface Protocol Standard (Gen2)”, is available at http://www.gs1.org/gsmp/kc/epcglobal/uhfc1g2/uhfc1g2_1_2_0-standard-20080511.pdf. RFID readers compatible with EPC Gen2 UHF RFID Reader standards are used for detection.

FIG. 2A is a block diagram showing an example embodiment of the detection and display circuitry 140 installed in the example apparatus 100. The example embodiment comprises a microprocessor as an example processing device 142 to operate as a central processing unit (CPU) 142a. A 7-inch touch screen-type LCD display 122b as an example of a first display device 122a is connected to the CPU 142a. A 4.3-inch LCD display 124b as an example of a second display device 124a is connected to the CPU 142a. The first and second detection devices 144, 146 are implemented in the form of a first antenna 144a and a second antenna 146a connected to a common radio-frequency circuitry 148. The radio-frequency circuitry 148 is connected to the CPU 142a. A wireless telecommunication interface 154a to facilitate data communication with external devices is also connected to the CPU 142a.

The detection and display circuitry 140 of FIG. 2A is to operate as a backbone or infrastructure of the apparatus of the present disclosure. An example implementation of the detection and display circuitry 140 of FIG. 2A is depicted in FIG. 2B and most of the control and operational circuitry is housed inside the main housing and underneath the display region 150. The example detection and display circuitry 140 of FIG. 2B which is to form an operational backbone of the apparatus 100 of FIG. 1 comprises a main control board 150 on which the CPU 142a, data storage devices, data input device, data output device, data communication devices, peripheral devices and other operational electronics are mounted. A wireless data communication device in the form of a WiFi module 154b is also connected to the CPU 142a to facilitate data communication between the apparatus and a WLAN (wireless local area network) and/or external network or devices. The data storage devices 158 include solid state memories such as RAM, ROM, SD card and other devices such as a hard disk. The input/out devices include USB/micro USB or other data I/O ports. The 7-inch touch screen-type LCD display 122b includes finger sensors and operates as an input port. The peripheral devices include a battery indicator, a microphone, speakers, or alarms. The main control board 150 obtains operation power from a secondary battery 152 and a power switch 156 is provided on the operator end 119a to turn on or turn off power supply to the main control board 150. A DC power socket 152a is provided on the operator end 119a to supply power to the main control board when an external DC power supply is operational. The RF circuitry comprises an RFID module 148a. The RFID module comprises an RFID interrogator module 148b and an RF isolator module 148c. The RFID module 148b is connected to the first antenna 144a which is to operate as an article detection antenna 144b and the second antenna 146a which is to operate as a peripheral antenna 146b. The RFID interrogator 148b is to transmit interrogation signals and to receive authentication replies from passive RFID tags and is available in module forms. A single RFID interrogator 148b is shared by the first 144a and second 146a antennae to facilitate a more compact, lighter weight and less costly portable apparatus.

As depicted in FIG. 2C, the RF module comprises an RF interrogator 148b which is connected to an RF switch 148c to facilitate shared use of a single RF interrogator by the first antenna 144a which is to operate as the article detection antenna 144b and the second 146a antenna which is to operate as the peripheral antenna 146b. The RF switch 148c is to facilitate alternative formation of a first RF signal path and a second RF signal path with adequate RF isolation between the two RF signal paths. In this example, the first RF signal path is formed by RF connection between the RF interrogator 148b and the article detection antenna 144b and the second RF signal path is formed by RF connection between the RF interrogator 148b and the peripheral antenna 146b. The example RF switch 148c has isolation of about or more than 40 dB between adjacent ports to provide the required RF isolation and to mitigate undesirable RF signal coupling between the two signal paths. In the example implementation as depicted in FIG. 2C, the RF signal power to be transmitted by the RF interrogator 148b for interrogation is set at 0 dBm. The detection sensitivity of each of the article detection antenna 144b and the peripheral antenna 146b is the same and is set to be −20 dBm.

Referring to FIG. 2D, the RF switch 148c comprises a first switching control port Ctrl A, a second switching control port Ctrl B, a first RF signal output port RF OUT 1, a second RF signal output port RF OUT 2, and an RF signal input port RF IN. The first and second switching control ports Ctrl A, Ctrl B are connected to corresponding control ports on the RF interrogator 148b to facilitate switching control of the RF switch 148c. The first RF signal output port RF OUT 1 is connected to the article detection antenna 144b to form the first RF signal path. The second RF signal output port RF OUT 2 is connected to the peripheral antenna 142b to form the second RF signal path. The RF signal input port RF IN is connected to an RF port of the RF interrogator 148b to form an RF signal path for transmission of interrogation signals to the antennae and receipt of response signals from the antennae 144b, 146b. The switching of the RF switch 148c is operated by control signals from the control ports of the RF interrogator 148b and the control signals are originated from the CPU 142a. The switching frequency or switching intervals of the RF switch 148c will determine the response time of the detection circuitry 140 and are typically set to meet a desirable response speed so that an operator can be made aware of status changes detectable at the antennae 144b, 146b within an anticipated time.

A typical switching frequency may be in the region of 1 Hz to 10 Hz so that RFID signals present at the antennae can be updated at intervals of between 0.1 second and a second. Where a quicker response time is required, the switching frequency may be set to be in the region of 10 Hz to 10 kHz so that the response time can be less than 100 millisecond (ms) and delay associated with the switched reading would not be human perceivable. In order to avoid confusing display of status information, the CPU may be set to only output such status information when the status has been stabilized, for example, no change in several seconds.

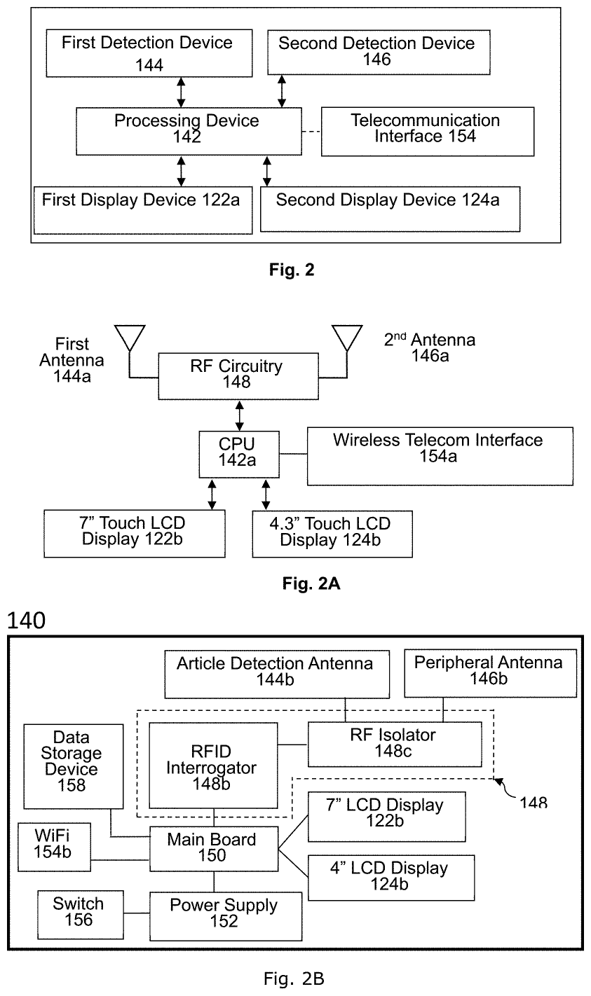

The first antenna 144a is configured as an article detection antenna 144b to detect articles on the main receptacle. In order that articles on the main receptacle 110 and carrying RFID tags can be effectively detected, the article detection antenna 144b is required to have an effective detection range covering at least the entire main surface 116 of the tray on the main receptacle 110. An example antenna suitable for covering the entire main surface 116 is a distributed antenna such as the article detection antenna 144b depicted in the partially exploded view of FIG. 3A. This article detection antenna 144b is substantially planar and has planar detection elements that are distributed and/or spread in an area comparable to the area of the entire main surface 116. The article detection antenna 144b is placed immediately underneath the main receptacle 110 with the detection plane defined by the planar detection elements parallel or substantially parallel to the main surface 116. To promote maximal detection of signals coming from articles held in the main receptacle 110, the planar area of the article detection antenna 144b as defined by the planar extent of the entirety of the planar detection elements is comparable to that of the main surface 116 of the tray and is aligned therewith so that the planar extent of the planar detection elements of the article detection antenna 144b substantially overlaps or coincides with that of the main surface 116 of the tray.

The article detection antenna 144b is to detect radio frequency signals coming in from RFID tags on the tray or the main receptacle 110. Radio frequency signals not coming from the tray or from the main receptacle 110 are treated as spurious or unwanted signals and the reception thereof is to be mitigated. To provide radio frequency shielding against unwanted or spurious signals, the article detection antenna 144b is mounted on the top surface 149 of a metal casing with the planar detection elements sitting on the top surface 149 of the metal housing and exposed to and facing the bottom surface of the main receptacle 110.

The metal casing has a planar extent comparable, if not slightly larger, than that of main receptacle and has a top surface 149 parallel to the main surface 116 of the tray so that when the article detection antenna 144b is mounted on the top surface of the metal casing, the planar detection elements are parallel to the main surface 116 for maximal detection of radio signals coming from the main surface 116 and minimal detection of radio signals coming from other orientations. As an optional feature, the metal casing may include a downwardly depending wall or skirt extending around boundary of the top surface to enhance radio frequency shielding. An alternative antenna layout suitable to operate as an article detection antenna is depicted in FIG. 3C. While each of the antennas depicted in FIGS. 3B and 3C include planar detection elements which are arranged in a spiral form to enhance more effective detection coverage, the antenna may be in other forms, for example, may follow the shape of the main receptacle 110 so that the detection elements are parallel to the sides of main receptacle and parallel to other detection elements on the same side of the receptacle and gradually spiraled towards its centre. In general, the overall shape and extent of the article detection antenna 144b will be comparable to the overall shape and extent of the 110 to facilitate more effective detection coverage. Another re-chargeable battery, for example, a tablet-shaped battery having a larger energy capacity than the battery 152a, is mounted on the lower housing and below the metal casing to provide operation power as part of the power supply 152.

The second antenna 146a is configured as a peripheral antenna 146b to detect radio frequency signals coming from outside of the apparatus 100 but not from RFID tags attached to articles on the main receptacle 110. The second antenna 146a is mounted near a corner on the operator's end 119a of the apparatus which is distal from the main receptacle 110. The mounting of the second antenna 146a at a location distal from the main receptacle 110 and hence the article detection antenna 144b is to mitigate detection of radio signals coming from the main receptacle. This peripheral antenna 146b has planar detection elements which are arranged to define a detection plane that is orthogonal or substantially orthogonal to the detection plane of the article detection antenna 144b. This peripheral antenna 146b is oriented to detect radio signals coming from outside of the apparatus and in a direction (−X) towards the lateral side of the apparatus distal from the main receptacle 110. The second antenna 146a is for detecting radio frequency signals coming in from a localised source such as an access card or a single RFID tag and therefore has a physical and detection area substantially less than that of the article detection antenna 144b. In an example, the second antenna 146a is formed on a printed circuit board and is inserted vertically into a vertical slot formed on the lower housing 114 so that its detection surface is outwardly (X-direction of FIG. 1A) facing. Radio frequency signal shielding is provided on the backside of the second antenna 146a to mitigate receipt of unwanted or spurious radio frequency signals coming from the backside of the second antenna 146a. The backside of the second antenna 146a is the side facing the main receptacle 110 and the unwanted or spurious radio frequency signals would include residual RFID signals coming towards the second antenna 146a after traversing the radio frequency shielding on the article detection antenna 144b.

While the article detection antenna 144b and the second antenna 146a are both formed as a printed circuit board (PCB) antenna with the detection elements imprinted on a substrate of a PCB, each or one of the antennae can be formed on other substrates or mediums and in a membrane form or a template form without loss of generality.

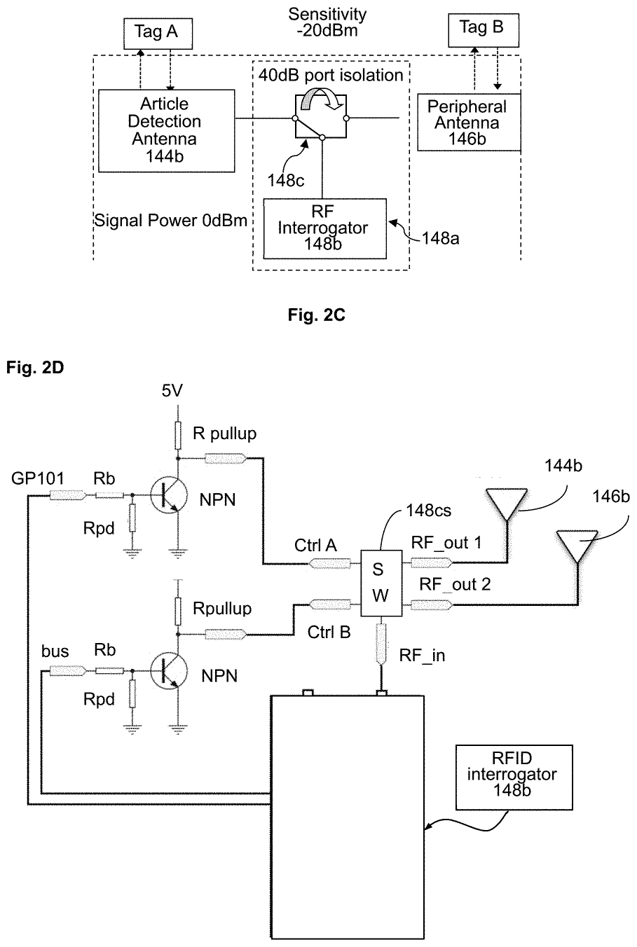

To use the apparatus 100, an operator will turn on the power switch 156 and the processor will execute initialization instructions to initialise. After completion of initialization procedures, the detection and display circuitry 140 will be activated and the apparatus 100 will be ready to operate upon validation of the access authorization of an operator by the processor 142a. Upon completion of the initialization process, an access invitation message such as an image showing how to access or ‘check in’ will be displayed on the second, larger, display 122 as depicted in FIG. 4A. A company logo or other non-sensitive information may be displayed on the first, smaller, display 124 as depicted in FIG. 4B. At this time, the detection and display circuitry 140 will be operational and the RF interrogator 148b will repeatedly transmit interrogation signals to the second antenna 146b to detect request for access. The interrogation signals may be sent at a higher repetition frequency, for example, 100 interrogations per second, to ensure a prompt response to a request to access. At this stage, the RF interrogator 148b does not need to send interrogation signals to the first antenna and the RF switch 148c may be maintained at a position corresponding to one that maintains constant connection of the second RF signal path to the RF interrogator 148b but not the first signal path.

To gain authorized access to operate the apparatus 100, an operator will present an RFID enabled access card to an access authorization detector on the apparatus 100. In this example, the second antenna 146a is configured as an access authorization detector and the portion of the main housing facing the detection surface of the second antenna 146a is grille-shaped to define a detection window 146c. An intended operator will present the RFID enabled access card to the detection window 146c which is on one lateral side of the apparatus 100 proximal the display region and the operator's end 119a. When the RFID information contained in the access card and detected by the apparatus 100 through operation of the RF interrogator 148b is verified by the CPU 142a as consistent with valid access authorization, the apparatus will enter into actual operation modes. As an additional feature or an alternative, an intended operator may access the apparatus 100 by entering an authorization code through an interactive input window on the touch screen 122 depicted in FIG. 4A.

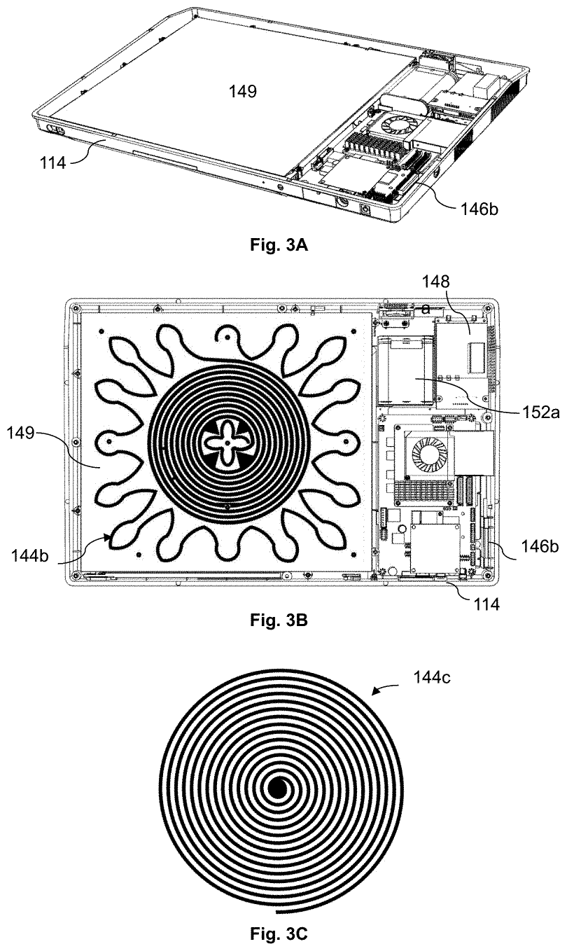

After access to the apparatus 100 has been validated, the apparatus 100 will enter into an operation mode upon execution of prescribed instructions. Initially, no article is on the main receptacle and nullity information corresponding to a condition of zeroes or ‘no article has been introduced’ will be displayed on the first 122 and second 124 displays as depicted in FIGS. 5A & 5B. When the apparatus 100 is in operation, the RF interrogator 148b will in response to instructions of the processor repeatedly send interrogation signals to the article detection antenna 144b to detect and monitor status of articles which carry RFID tags and are on the main receptacle 110. In addition, the RF interrogator 148b will in response to instructions of the processor 142 repeatedly send interrogation signals to the second antenna 146b to detect and monitor conditions corresponding to conditions requiring attention or special treatment. As there may be a plurality of articles carrying RFID tags on the receptacle at the same time, and movement of such articles in and out of the man receptacle 110 may be expected to more frequently occur than conditions that can be expected to be detectable at the second antenna 146b, the time used by the RF interrogator 148b to serve the article detection antenna 144b will be substantially higher than that used to serve the second antenna 146b where a single RF interrogator 148b is shared between the two antennae so that interrogation signals need to be sent alternatively to the antennae.

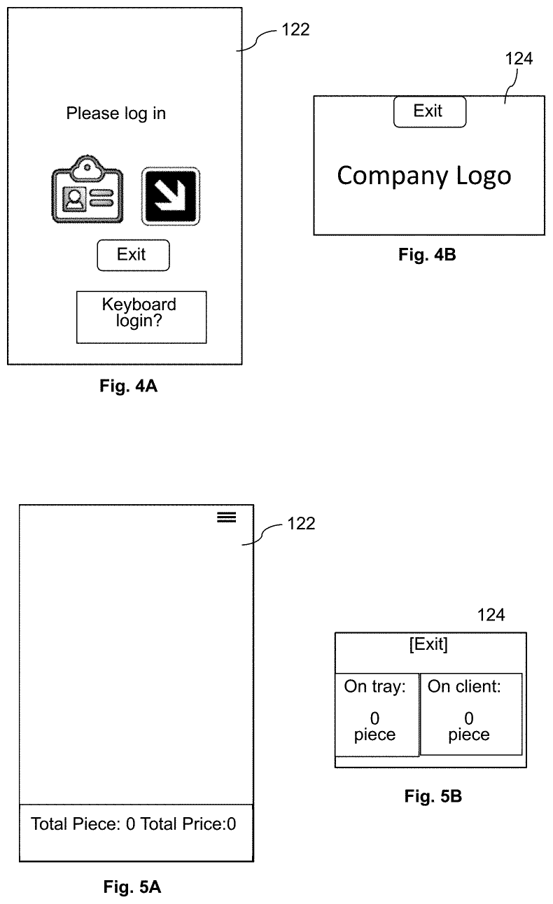

Example operation of the apparatus 100 will be described with reference to the flow diagram 1100 of FIG. 6. After the apparatus 100 has entered into operational mode at 1110, the RF interrogator 148b will send encoded interrogation signals to the article detection antenna 144b, as depicted in 1120. When radio signals received at the RF interrogator 148b are from the article detection antenna 144b and correspond to RFID signals, the RF interrogator 148b will forward decoded RFID information containing article identification information to the processor 142 at 1130. Upon receipt of the article identification information, the processor 142 will determine whether the article identification information received include that of a new article or an existing article at 1140. If the received article identification information includes that of a new article or a plurality of new articles, the processor will generate information relating to the new article or articles and display the relevant article information on the first display at 1150. If the received article identification information corresponds to article identification information of existing articles, the processor will determine whether an existing article which was present during the last update has become missing and whether any existing article which was absent during the last update has become present again and to provide presence and absence information on the first display 124 at 1160. An article is described as a ‘new article’ herein if the article is introduced into the main receptacle 110 for the first time during the current presentation session or viewing session. An article is described as an ‘existent article’ herein if the article has been introduced into the main receptacle 110 during the current presentation session or viewing session. An article is described as a ‘floating article’ herein if the article has been introduced into the main receptacle 110 but has been temporarily moved out of the main receptacle 110 and has not be returned to stock or ‘checked out’.

In order to assist an operator to track movement of RFID tagged articles after introduction into the apparatus during a customer serving session, the processor 142 is to maintain a first counter and a second counter. The first counter (“presence counter”) is to track the number of RFID tagged articles which are present on the main receptacle. The second counter (“absence or floating counter”) is to track the number of RFID tagged articles which are moved out of the main receptacle after introduction into the main receptacle and before returning to the shop's stock. The instantaneous value of the first counter is to be displayed in a first sub-window on the second display 124 and the instantaneous value of the second counter is to be displayed in the second sub-window to provide visual assistance to the operator.

As shown in FIG. 5B, the second display 124 includes a first sub-window to provide the number of articles which has been introduced into the main receptacle and a second sub-window to provide the number of articles which are floating articles. A floating article is presumed to be with a current viewer and the number of floating articles is displayed under the heading “on the client” in the second sub-window. In this example, the first sub-window of the second display 124 is for indicating the number of articles that is present on the main receptacle and the second region of the second display is for indicating the number of articles that is moved out of the main receptacle 110 after introduction into the main receptacle but not yet checked out. In processing terms, the first sub-window is to display the instantaneous numerical value of a first counter corresponding to a presence counter and the second sub-window is to display the instantaneous numerical value of a second counter corresponding to an absence counter, In operation terms, the first sub-window of the second display 124 is for indicating the number of articles that is present on the main receptacle and the second region of the second display is for indicating the number of articles that is moved out of the main receptacle 110 after introduction into the main receptacle but not yet checked out.

Referring to the flow diagram 1200 of FIG. 6A, an article will be treated as a floating article at 1210 when the article is removed from the main receptacle 110 after introduction. Where a floating existent article is to be returned to the stock, the operator will present that article to the detection window 146c and the floating article will be deregistered from the list of existent or introduced articles at 1220. After de-registration, the number of floating articles will be updated at 1230. The de-registration process is also referred to as a ‘checking out’ process herein. As the article identification antenna 144b operates to detect introduction of an article into the main receptacle, the article identification antenna 144b is also described as a ‘check-in antenna’ herein. Where the second antenna 146b is to operate to de-register an article from the list of ‘existent articles’, the second antenna 146b will also be referred to as a ‘check-out antenna’ or a ‘checkout antenna’, and the detection window 146c will then serves as a check-out port or a checkout port. Of course, the second antenna 146b has other functions as described herein such as to facilitate access request detection.

In some modes of operation, the apparatus 100 is to operate to monitor and track articles introduced into the main receptacle and their subsequent status.

Referring to the flow diagram 1300 of FIG. 6B, the processor 142 in such modes of operation is to operate the first detection device 144 to detect and collect article identification data from RFID tagged articles on the main receptacle 110 after initialization has completed as depicted in 1310. Upon collection of article identification data from the main receptacle 110, the processor is to compare the collected article identification data with article identification data stored in the local data storage as depicted in 1320. The identification data stored in the local data storage are article identification data collected during the last round of data collection and has included information on number of articles present on the main receptacle and number of floating articles and their respective identification date. If the collected article identification data include new article identification data of an article which was not previously collected and registered in a current viewing session, that new article identification data will be treated by the processor as corresponding to an article which is newly introduced into the main receptacle. Upon detection of the presence of a new article on the main receptacle, the processor will at 1330 register the new article as an “introduced item”, to store the article identification data of the newly introduced article, and update a presence counter to keep track on the total number of articles introduced into the apparatus during a session. The processor will determine (with reference to the stored article identification data) whether any registered article identification data is not present (or is absent or missing) in this latest round of article identification data collection at 1340, and to determine whether the missing article identification data corresponds to that of a checked-out or de-registered item at 1350. If the missing article identification data corresponds to that of a checked out item, the number of floating articles will be reduced compared to last number. If the missing article identification data does not correspond a checked out item, the number of floating articles will be increased compared to last number. At 1360 the processor will update an absence counter to keep track on the total number of instantaneous floating articles in the current viewing session.

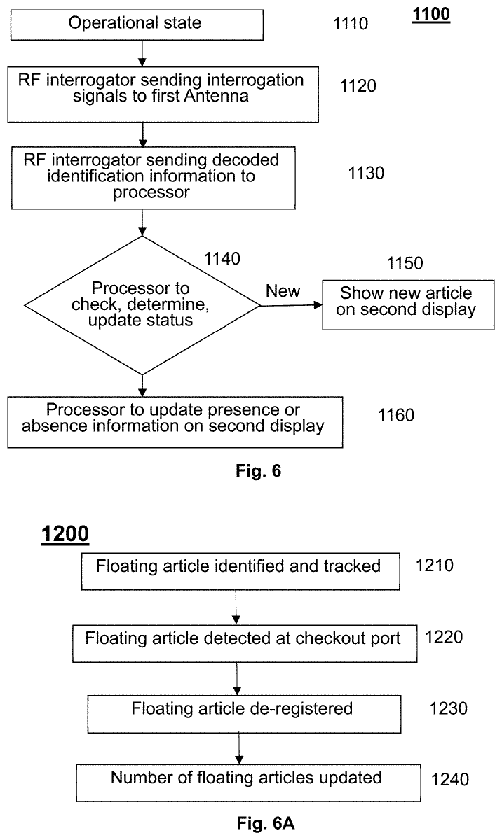

Example operations during an example viewing session will be explained with reference to FIGS. 7A to 10B.

After completion of the initialization process, an article having an associated RFID tag (an “RFID tagged article”) is introduced into the main receptacle by an operator and placed on the velvet floor of the main receptacle 110. When the check-in antenna has detected the RFID signals emitted by the RFID tag associated with the newly introduced article, the processor 142a will search through its accessible databases and retrieve product related information associated with that specific RFID. In this example, EPC code is used as an example of unique identification code for retrieving information relating to an RFID tagged article. The accessible databases may include databases stored on the apparatus or accessible via telecommunications means such as the WiFi frontend or LAN connection. Selected product related information will be displayed on the first display as depicted in FIG. 7A. The processor will increment the presence counter by 1 and the number “1” is displayed on the first sub window of the second display as depicted in FIG. 7B as there is one RFID tagged article introduced into and present on the main receptacle 110. At this time, there is no floating article, and the number “0” is displayed on the second display portion of the second display to indicate that there is no floating article. In this example, the first RFID tagged article that is introduced into the apparatus 100 is a gold ring.

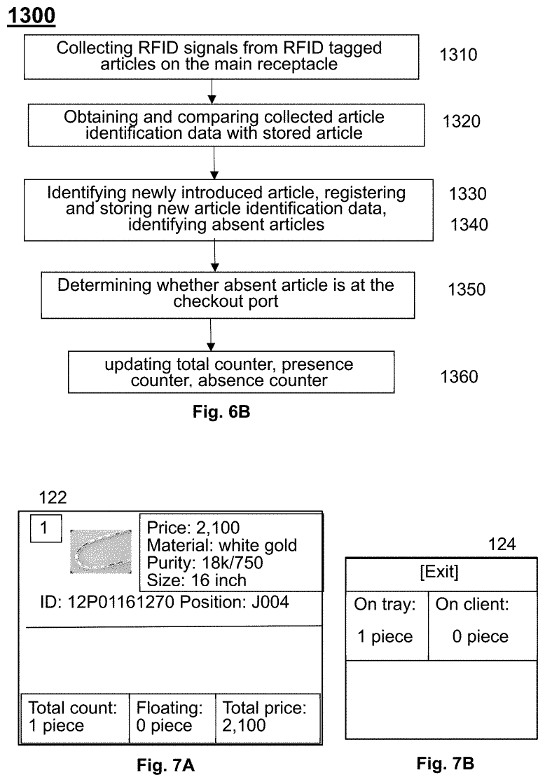

Next, a second RFID tagged article is introduced into the main receptacle 100 by the operator. With the introduction or “checking-in” of the second RFID tagged article, there is now a total of two RFID tagged articles introduced into and present on the apparatus. Upon detection of the second RFID tagged article by the check-in antenna 144b and the processor selected information relating to the newly introduced article will be presented in the first display as depicted in FIG. 8A. The processor will increment the presence counter by 1 and update the first display region of the second display so that the number “2” is displayed to indicate that a total of two RFID tagged articles is present on the main receptacle 110, and the number “0” is displayed on the second display portion of the second display to indicate that there is no floating article, as depicted in FIG. 8B. In this example, the second RFID tagged article that is introduced into the apparatus 100 is a gold pendant.

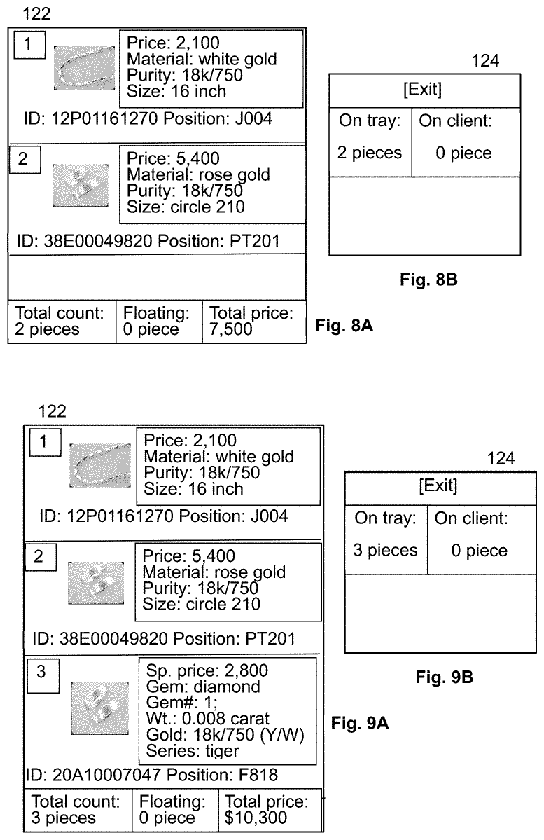

A third RFID tagged article is introduced into the main receptacle by the operator. With the introduction of the second RFID tagged article, there is now a total of three RFID tagged articles introduced into and present on the apparatus 100. Upon detection of the presence of the third RFID tagged article by the check-in antenna 116 and the processor, the processor will update the first display region of the second display so that the number “3” is displayed to indicate that a total of three RFID tagged articles is present on the main receptacle 110, and the number “0” is displayed on the second display portion of the second display to indicate that there is no floating article, as depicted in FIG. 9A. Selected product related information of all the three RFID tagged articles is also retrieved from the product database and displayed on the first display by the processor as depicted in FIG. 9B. In this example, the first RFID tagged article that is introduced into the apparatus 100 is a diamond ring.

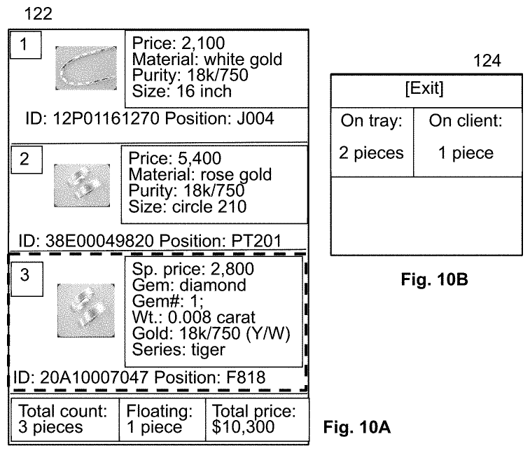

One of the three RFID tagged articles is then moved out of the main receptacle 110 for customer viewing and that moved article will be out of the detection range of the check-in antenna 144b. When the presence tracking assembly comprising the check-in antenna 144b and the processor 142 can no longer detect the presence of that article on the main receptacle 110, the assembly will take the non-detection as an indication that the article has been moved out of the main receptacle. At this time, the process will decrement the presence counter by “1” and increment the absence (or floating) counter by “1” to reflect the removal as depicted in FIGS. 10A and 10B. As an optional feature, part of the product related information relating to the floating article, for example, the product ID or appearance may have a different visual representation to that of the articles present on the main receptacle so that the operator can have the immediate knowledge of which specific article is or articles are floating. The difference in visual representation may be by way of different colour schemes, flashing, highlight, or other forms without loss of generality.

When the floating article is returned to the main receptacle 110, the presence tracking assembly will update the information and the states of the display will return to that of FIGS. 9A and 9B.

On the other hand, if the operator decides to return the floating article to the shop's stock or inventory control, the operator will place the RFID tagged article against the check-out port 146c. When the RFID tagged article is placed in proximity of and against the check-out port 146c, it is within the detection range of a check-out assembly comprising the check-out antenna 146b and the processor 142. When the processor 142 has detected presence of the RFID tagged article at the check-out port, the processor will register that RFID tagged article as a “checked-out” article. Once an article has been checked out and registered as a checked-out article, the apparatus will no longer track its movement or whereabouts unless the article is re-introduced onto the main receptacle. When the article has been checked out, the processor 142 will update its counter, including the presence counter and the absence counter, to reflect the discharge of an article from scrutiny measures provided by the apparatus.

When a viewing session has come to an end, an operator can according to the information on the apparatus complete a purchase transaction.

In this example, the floating article is the last article introduced into the main receptacle which is depicted in FIG. 9A. Upon checking out of this last article, the first display is updated so that the product information relating to this first article is no longer shown. In addition, the presence counter and the absence counter are also updated to reflect that the first article has been checked out. Specifically, each of the presence and absence counters is decrement by 1 to reflect the check out or discharge. At this point, the information displayed on the first and second displays are restored to that of FIGS. 8A and 8B.

It will be noted that when the RFID tag at the check-out port 136c is out of the detection range of the check-in antenna 144b due to the distance of separation as well as the RF shielding, the presence of the RFID tag at the check-out port will not be detected by the check-in antenna, even though the physical separation between the check-out port and the check-in antenna is in the region of 10-15 cm only.

The RFID tag used in this example is formed on one side of a foldable label carrying selected product related information such as product ID, serial number, price, quality, or other relevant description or information. An RFID antenna is integrally formed on the other side of the foldable label and an RFID circuit is bonded to the antenna. A miniaturised and foldable RFID tag is useful for article of a small size and high value, such as jewelry items of the present examples. The RFID tags are folded into one third of the unfolded size.

After the customer sessions has ended, the operator will check out all the articles remaining on the main receptacle individually or simply authorize bulk check out of all items by activating a bulk check out function. In the example apparatus, the display region 120 and the detection window 146c are both located on the right side of the apparatus 100 to suit a right-handed user. The display region 120 and the detection window 146c may alternatively be located on the left side of the apparatus 100 to suit a left handed user. In some embodiments, the display region 120 and the detection window 146c may be located on the middle of the apparatus 100 so that the main receptacle 100 comprises trays on both sides of the display region 120, and with the detection window 146c on the operator's end.

At the end of the customer serving session, the identification of articles which have been introduced into the main receptacle and/or the identification of articles which have been moved out of the main receptacle for customer examination will be logged for subsequent or future use. To distinguish between the removal of an article form the main receptacle for customer viewing and that for straight check out, a threshold floating time, say 10-20 seconds, may be used to differentiate the two types of action. For example, where the floating time exceeds 10 seconds, the floating time will be interpreted as corresponding to customer viewing, rather than straight check-out.

To further utilise the logged information, the apparatus includes an interactive process to collect information regarding the customer of that customer serving session for future use. The process may include the steps of the operator entering information relating to personal particulars, events that trigger the purchase or the shopping exercise, purpose of the purchase or the shopping exercise, geographic origin of the customer, language used by the customer, or other information which may be used for service and/or business enhancement. In some modes of operation, the apparatus 100 is to cooperate with external databases. For example, the apparatus 100 may cooperate with external databases to obtain and prepare presentation information for a viewer. In general, presentation information to be presented to a viewer during a viewing session typically comprises “article specific information” which is information specific to an article and “general information” which is information relating but not specific to an article. Article specific information typically includes selected information relating to shape, appearance, style, quality, colour, grade, purity, weight, total number of articles in production, number of articles in stock, pricing formulae, latest auction or bid prices and/or certification number of the article. Article specific information may optionally include promotion information on a particular article such as extra discount, rebates, etc. General information is typically non-article specific information and typically includes selected general information such as information relating to merchandise price such as price of precious metals including gold, silver, platinum, etc.; price of precious stones including diamond, sapphire, emerald, jade, etc.; currency exchange rates; promotional discounts to a class of customers such as loyalty member scheme or credit card schemes.

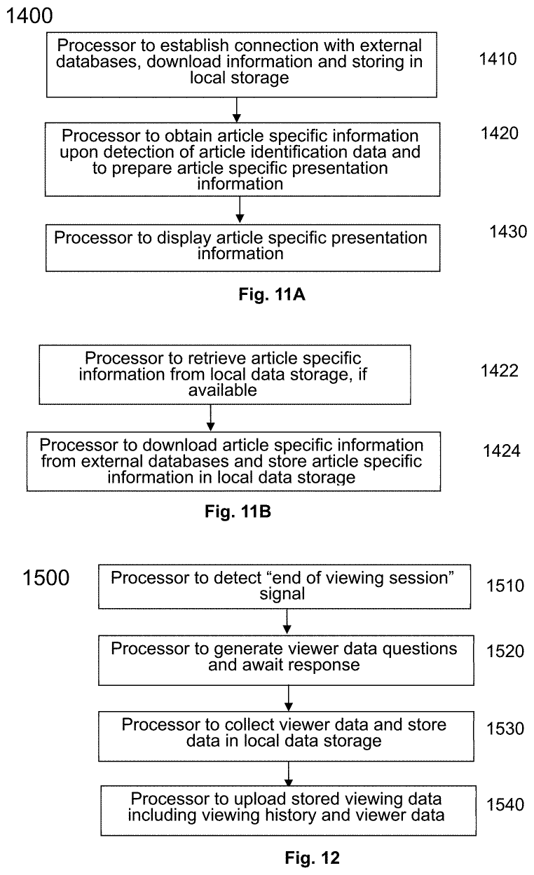

Referring to the flow diagram 1400 of FIG. 11A, the processor 142 upon completion of initialization of the apparatus 100 will establish data connection with external databases via the telecommunications interface 154 and download information which may be used in subsequent viewing sessions at 1410. The information to be downloaded may include time-variant information such as merchandise price information, currency exchange rates, and current or special promotional schemes. In addition, the information to be downloaded may include article specific information. Such article specific information may be on items which have been identified as popular or hit items. The article specific information may contain time invariant or non-time sensitive information such as article identification number, information on shape, appearance, size, style, quality, content, colour, grade, purity, weight, and/or certification number of the article; and/or time variant information such as the total number of articles in production, total number sold, number in stock, identification of shops having stock, pricing formulae, special sale terms, etc. The downloaded information is stored in local data storage devices 158 for subsequent use.

When an actual viewing session begins, the processor 142 will upon detection of a newly introduced article prepare presentation information specific to that article for display at 1420. The article specific presentation information to be displayed is primarily article specific information comprising time invariant information and time variant information. For example, the time invariant information being displayed on FIG. 9A includes gold content, weight, shape and appearance, size, position, and article identification data of the articles, while the offer prices are example of time variant information. Where the article specific information is available locally, the processor will retrieve the relevant information from the local data storage. Otherwise, the processor will request the article specific information from the external database by sending the associated article identification data to the external databases. The price information is computed according to a formula which is specific to the article with reference to time variant merchandise price information. After the price has been calculated, article specific presentation information will be displayed on the first display 122 at 1430, with individual price set out adjacent a graphic representation of the article and total price set out at the bottom of the first display 122 as depicted in FIGS. 7A, 8A, 9A and 10A.

Referring to the flow diagram of FIG. 11B, the processor will search for article specific information in the local data storage at 1422 to facilitate preparation of presentation information. If the article specific information in not available in the local data storage, the processor will contact external databases to download the article specific information at 1424. When an article is removed from the main receptacle during an active viewing session, whether for viewing or for checking out, the processor 142 will upon detection of a status of absence of the article from the main receptacle classify the article as a “floating article” and generates visual indicia on the first display 122 to inform the operator of such as status until the article is subsequently checked out or returned to the receptacle.

During the course of a viewing session, the processor 142 will operate to log and store the viewing history in the local data storage. The information to be logged to form a viewing history includes the identification data of the articles introduced into the main receptacle, the identification of articles removed for viewing, the number of viewings per article, the total viewing duration of a viewed article, and/or the article purchased. The viewing history will be uploaded to external data storage for subsequent processing and use for information compilation.

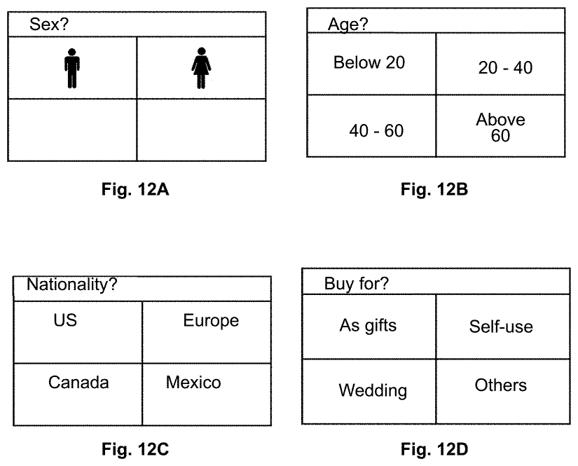

In some modes of operation, the apparatus 100 is to operate to collect viewer information after the completion or end of a viewing session. Upon detection of signals indicating the end of a viewing session, the processor 142 will execute instructions to enter into viewer data collection mode as depicted in the flow diagram 1500 of FIG. 12. Referring to FIG. 12, an operator is to inform the apparatus 100 that a viewing has come to an end by sending a command to the apparatus 100 at 1510. The command may be in the form of touching an [end of viewing session] icon on the display, for example the first display having touch screen sensors. Upon receipt of the “end of viewing session” command, the processor 142 will generate questions with accompanying icons on the display at 1520 and await operator response. The icons will appear sequentially to facilitate sequential response by an operator. Example questions may include gender of viewer as depicted in FIG. 12A, age group as depicted in FIG. 12B, geographic origin as depicted in FIG. 12C, and purpose of that viewing session as depicted in FIG. 12D. After responses have been received, the collected viewer data will be linked with the viewing and/or purchasing information of that viewing session and stored in the local data storage at 1530. The collected viewer data together with the viewing and/or purchase information will be uploaded to external data storages for subsequent data processing at 1540. Data collected by different viewing apparatus will be uploaded to a data processing facility for subsequent use and analyses. The uploaded data may be from different presentation apparatus with unique individual identification data and from different locations with location identification data to facilitate data analyses. The data uploading may be in response to polling of the data processing facility or by scheduled upload set in the apparatus 100. In some examples, the data uploading may be at the end of a business day so that all viewing data collected during that business day are uploaded. The viewing data may include viewing information such as identification data of item or items presented in that viewing session, identification data of item or items viewed, and number of viewing per item during that viewing session; purchase information including identification data of item or items purchases, per-item purchase price and total purchase price resulted from that viewing session; and viewer data.

After the viewing session has been completed and before the viewing data are uploaded to the data processing facility, the viewing data will be stored in the local data storage. The general information and the article specific information downloaded during the last viewing session will be kept for retrieval and possible use during subsequent viewing sessions. Where as a result of analyses of recently collected viewing data, some articles or class of articles are of particular demand or interest to viewers, specific data on such articles and classes of articles will be downloaded at initialization for more expeditious presentation of information to meet anticipated demand.

While the present disclosure has been illustrated with reference to the above example, it should be appreciated that the examples are for illustration only and shall not be used to restrict scope of the disclosure. For example, while various standards and protocols have been used herein for convenience, it should be understood that the present disclosure is not limited to such standards and/or protocols. Furthermore, where an apparatus comprising a processor is described, it should be appreciated that the processor can be a single processor, multiple processors, a cluster of processors, or distributed processors without loss of generality. Where a method or process is described herein, it should be appreciated that the method or process can be implemented by means of hardware, software, firmware or a combination thereof without loss of generality.

Table of numerals

| | | | |
|---|---|---|---|
| Apparatus | 100 | Display region | 120 |
| Main receptacle | 110 | First display | 122 |
| Upper housing | 112 | First display device | 122a |
| Lower housing | 114 | 7-inch touch screen LCD | 122b |
| | | display | |
| Main surface of tray | 116 | Second display | 124 |
| Peripheral of tray | 118 | Second display device | 124a |
| operator's end | 119a | 4-inch LCD display | 124b |
| viewer's end | 119b | Main control board | 150 |
| detection and display | 140 | Power supply | 152 |
| circuitry | | | |
| processing device | 142 | Secondary battery | 152a |
| CPU | 142a | WiFi | 154 |
| first detection device | 144 | Power switch | 156 |
| first antenna | 144a | Local data storage | 158 |
| Article detection antenna | 144b | RF circuitry | 148 |
| second detection device | 146 | RFID module | 148a |
| second antenna | 146a | RFID interrogator | 148b |
| peripheral detection | 146b | RF Switch | 148c |
| device | | | |
| detection window | 146c | Top surface of metal | 149 |
| | | casing | |

1) A serving apparatus comprising a main housing, a main receptacle, a checkout port, a display region comprising a display device, an RFID first detector comprising a first antenna, an RFID second detector comprising a second antenna, a data storage device, and a processor;
wherein the main receptacle comprises a main surface for holding a plurality of RFID tagged articles for customer viewing and selection;
wherein the first antenna is configured to detect RFID signals of RFID tagged articles on the main receptacle, and is radio-frequency shielded against detection of RFID signals of an RFID tagged article placed at the checkout port;
wherein the second antenna is configured to detect RFID signals of an RFID tagged article which is outside of the main housing, which is present at the checkout port, and which is not on the main receptacle; wherein the second antenna is radio-frequency shielded against detection of RFID signals of an RFID tagged article placed on the main receptacle, and is radio-frequency isolated from the first antenna;
wherein the processor is configured to operate the RFID first detector to continuously detect and collect RFID signals of an RFID tagged article or a plurality of RFID tagged articles on the main receptacle, to check in or register an RFID tagged article as a checked-in article when the RFID tagged article is detected by the first antenna of the RFID first detector for a first time during a serving session, and to collect and store product identification information of the checked-in article in the data storage device;
wherein the processor is configured to operate the RFID second detector to detect RFID signals of an RFID tagged article presented at the checkout port, and to checkout or deregister a checked-in article as a checked-out article when the RFID signals of the checked-in article are detected by the second antenna of the RFID second detector; and
wherein the processor is configured to determine and classify a checked-in article as a floating article if the checked-in article is not detected by the RFID first detector or the RFID second detector for a floating time exceeding a threshold time, and to generate and store absence information of the article, the absence information including product identification information of the floating article, the floating time, the total floating time and/or number of absence of the checked in article during the serving session.

2) The serving apparatus of claim 1, wherein the main surface comprises an upward-facing planar surface, and wherein the first antenna is disposed intermediate the upward-facing planar surface and a metal casing for maximal detection of RFID signals coming from the main surface and for minimal detection of RFID signals coming from other orientations.

3) The serving apparatus of claim 2, wherein the first antenna is a distributed antenna having planar detection elements which define a detection plane, the detection plane being parallel to a top surface of the metal casing; and wherein the first antenna is mounted immediately underneath the main receptacle and sits on the top surface of the metal casing, the top surface of the metal casing being parallel to the main surface of the main receptacle.

4) The serving apparatus of claim 3, wherein the top surface of the metal casing has a planar extent which is comparable to the planar extent of the main surface of the receptacle.

5) The serving apparatus of claim 1, wherein the second antenna is configured to detect RFID signals of a localized RFID signal source which is outside the apparatus.

6) The serving apparatus of claim 5, wherein the first antenna is configured to detect RFID signals coming to the first antenna in a first axial direction which is a downward direction, and wherein the second antenna is configured and oriented to detect RFID signals coming to the second antenna and the apparatus in a second axial direction which is an inward direction orthogonal to the first axial.

7) The serving apparatus of claim 6, wherein the first antenna has a horizontal detection surface and the second antenna has a vertical detection surface.

8) The serving apparatus of claim 6, wherein the first antenna is a distributed antenna having a detection area covering the main receptacle, and wherein the second antenna has a detection area which is smaller than the detection area of the first antenna and which covers the checkout port.

9) The serving apparatus of claim 8, wherein the first antenna is a distributed antenna having a detection range covering the main receptacle, and wherein the checkout port is outside the detection range of the first antenna.

10) The serving apparatus of claim 6, wherein the second antenna has an outward-facing front side and an inward-facing backside, and wherein the backside is radio-frequency shielded to prevent detection of residual RFID signals coming in from the first antenna.

11) The serving apparatus of claim 10, wherein the front side of the second antenna is adjacent the checkout port.

12) The serving apparatus of claim 5, wherein the main housing comprises an upper housing portion and a lower housing portion which cooperate to form the main housing, wherein the main receptacle is formed on a top surface of the main housing to define an open tray and an upward facing main surface, wherein the checkout port is formed on a lateral side of the main housing and a portion on the lateral side of the main housing which is opposite-facing the second antenna is formed as a grille-shaped checkout port, and wherein the display region is intermediate the lateral side of the main housing and the main receptacle.

13) The serving apparatus of claim 12, wherein the main receptacle is formed as an indented portion on a top surface of the main housing, and wherein the main surface is depressed below the top surface and surrounded by an upwardly extending peripheral wall.

14) The serving apparatus of claim 13, wherein the first antenna sits on a metal casing having a skirt, and wherein the skirt of the metal casing defines the peripheral wall and surrounds the main surface of the main receptacle.

15) The serving apparatus of claim 12, wherein the apparatus has an operator end and a customer end, and the main receptacle is intermediate the operator end and the customer end; wherein the upper housing includes an inclined portion which is adjacent the main receptacle and which inclines towards the operator end, wherein the display device is mounted on the inclined portion with its display surface inclined towards operator end so that the display surface is readable from the operator end but not from the customer end; and wherein the processor is configured to display article specific information of a floating article on the display device.

16) The serving apparatus of claim 1, wherein the apparatus comprises a first RF signal path which comprises the RFID first detector and a second RF signal path which comprises the RFID second detector, and wherein the second RF signal path is radio-frequency isolated from the first RF signal path.

17) The serving apparatus of claim 1, wherein the processor is configured to display a selected portion of the absence information and a selected portion of the product identification information of the floating articles on the display device during the serving session, the product identification information including one or more of the following: shape, appearance, style, weight, price, material, grade, purity, number in stock, and available discount.

18) The serving apparatus of claim 16, wherein the processor is configured to use the absence information to form a viewing history of viewed checked in articles after the serving session; and wherein the viewing history includes the product identification information of the checked in articles, the product identification information of the checked in articles which were removed for viewing, the number of viewings per checked in article, the total viewing duration of the checked in articles viewed, and/or the checked in articles purchased.

19) The serving apparatus of claim 17, wherein the processor is configured to collect and store customer specific information and to associate said customer specific information with the viewing history; and wherein the customer specific information includes one or more of the following types of information of a customer: gender, age, demographic data, articles purchased, purposes of or events leading to purchase in said serving session.

20) The serving apparatus of claim 1, wherein the apparatus is configured as a desktop apparatus or a portable apparatus.
